(19) United States
(12) Patent Application Publication
(10) Pub. No.: US 2017/0322659 A1
(43) Pub. Date: Nov. 9, 2017

(54) TOUCH-SENSITIVE CONTROL DEVICE

(71) Applicant: Touchplus Information Corp., NEW TAIPEI CITY (TW)

(72) Inventors: Shih-Hsien HU, New Taipei City (TW); Chi-Chou HO, New Taipei City (TW)

(21) Appl. No.: 15/590,158

(22) Filed: May 9, 2017

(30) Foreign Application Priority Data
May 9, 2016 (CN) 201610300828.8

(51) Int. Cl. G06F 3/041; G06F 3/044; G06F 3/0488; G06F 3/0354; G06F 1/16

(52) U.S. Cl. CPC G06F 3/0414; G06F 3/044; G06F 1/1643; G06F 3/03547; G06F 3/0488

(57) ABSTRACT

A touch-sensitive control device is controlled by a control chip to conduct press sensing and/or touch sensing. The touch-sensitive control device includes: a cover; a circuit board disposed at a side of the cover, having a first surface disposed opposite to the cover, and having a second surface facing the cover; a first electrode disposed on the first surface of the circuit board and electrically connected to a control chip; a socket having a conductor; and a spacer disposed between the socket and the first surface of the circuit board, and deformable to change a distance between the first electrode and the conductor, wherein a capacitance change between the first electrode and the conductor of the socket correlates to the distance change between the first electrode and the conductor resulting from a pressing operation onto the cover.

### FIELD OF THE INVENTION

The present invention relates to a touch-sensitive control device, and more particularly to a touch-sensitive control device for use in a smart phone.

### BACKGROUND OF THE INVENTION

Please refer to FIG. 1, which schematically illustrates appearance of a smart phone 1. In general, the smart phone 1 has a touch screen 10 and a home key 11 arranged on or near the touch screen 11. In some smart phones, the home key 11 is a mechanical push button, which can be physically pushed down, and is thus subject to abrasion and humidity damages. The home key 11, in other smart phones, may be implemented with a virtual key, which is activated in response to user's touch thereonto. A virtual touch key would not suffer from abrasion and humidity problems. However, it is generally hard for a user to perceive a touch operation on such a virtual home key, and it is adverse to identification of a touch operation. Moreover, the lack of feedback while pressing the key deviates from common using habits.

### SUMMARY OF THE INVENTION

Therefore, the present invention provides a touch-sensitive push button of a smart phone, which feeds back feeling of press while being pushed.

An aspect of the present invention relates to a touch-sensitive control device, controlled by a control chip to conduct press sensing and/or touch sensing. The touch-sensitive control device includes: a cover; a circuit board disposed at a side of the cover, having a first surface disposed opposite to the cover, and having a second surface facing the cover; a first electrode disposed on the first surface of the circuit board and electrically connected to a control chip; a socket having a conductor; and a spacer disposed between the socket and the first surface of the circuit board, and deformable to change a distance between the first electrode and the conductor, wherein a capacitance change between the first electrode and the conductor of the socket correlates to the distance change between the first electrode and the conductor resulting from a pressing operation onto the cover.

In an embodiment, the touch-sensitive control device further includes a second electrode disposed on the second surface of the circuit board and electrically connected to the control chip; and a third electrode disposed on the first surface of the circuit board and electrically connected to the control chip, wherein the second electrode is capacitively coupled to the third electrode, and a capacitance change between the second electrode and the third electrode correlates to a touching operation on or over the cover.

The present invention further provides a touch-sensitive control device, comprising a cover; a control chip; a circuit board disposed at a side of the cover, having a first surface disposed opposite to the cover, and having a second surface facing the cover; a first electrode disposed on the first surface of the circuit board and electrically connected to a control chip; a socket having a conductor; and a spacer disposed between the socket and the first surface of the circuit board, and deformable to change a distance between the first electrode and the conductor. The control chip generates a first control signal in response to a capacitance change between the first electrode and the conductor of the socket in a first period of time, and the capacitance change correlates to a distance change between the first electrode and the conductor in response to a pressing operation on the cover.

In an embodiment, the touch-sensitive control device further includes a second electrode disposed on the second surface of the circuit board and electrically connected to the control chip; and a third electrode disposed on the first surface of the circuit board and electrically connected to the control chip, wherein the control chip generates a second control signal in response to a capacitance change between the second electrode and the third electrode in a second period of time, and the capacitance change correlates to a distance change between the second electrode and the third electrode in response to a touch-sensing operation on or over the cover.

In another aspect, the present invention provides a touch-sensitive control device, controlled by a control chip to conduct press sensing and/or touch sensing, which includes: a cover; a flexible circuit board disposed at a side of the cover and folded to define an upper portion and a lower portion; a first electrode disposed at an inner surface of the lower portion facing the upper portion, and electrically connected to the control chip; a second electrode disposed at an inner surface of the upper portion facing the lower portion, and electrically connected to the control chip; and a spacer disposed between the first portion and the second portion of the flexible circuit board for creating a variable gap between the first electrode and the second electrode, wherein a distance between the first electrode and the second electrode changes in response to a pressing operation, and a capacitance change between the first electrode and the second electrode correlates to the distance change.

In an embodiment, the touch-sensitive control device further includes a third electrode disposed at an inner surface of the lower portion facing the upper portion, and electrically connected to the control chip; and a fourth electrode disposed at the outer surface of the lower portion opposite the upper portion, and electrically connected to the control chip, wherein the third electrode is capacitively coupled to the fourth electrode, and a capacitance change between the third electrode and the fourth electrode is measured by the control chip in response to a touching operation on or over the cover.

In a further aspect, the present invention provides a touch-sensitive control device, which includes a cover; a flexible circuit board disposed at a side of the cover and folded to define an upper portion and a lower portion; a first electrode disposed at an outer surface of the lower portion opposite to the upper portion, and electrically connected to the control chip; a second electrode disposed at an outer surface of the upper portion opposite to the lower portion, and electrically connected to the control chip; and a spacer disposed between the first portion and the second portion of the flexible circuit board for creating a variable gap between the first portion and the second portion, wherein the control chip generates a first control signal in response to a capacitance change between the first electrode and the second electrode in a first period of time, and the capacitance change correlates to a distance change between the first electrode and the second electrode in response to a pressing operation on the cover.

In an embodiment, the control chip generates a second control signal in response to a capacitance change of the second electrode in a second period of time, and the capacitance change occurs in response to a touching operation on or over the cover.

### BRIEF DESCRIPTION OF THE DRAWINGS

The invention will become more readily apparent to those ordinarily skilled in the art after reviewing the following detailed description and accompanying drawings, in which:

FIG. 1 is schematic diagram illustrating appearance of a common smart phone;

FIG. 2 is a schematic diagram illustrating application of a touch-sensitive control device according to the present invention to a smart phone;

FIG. 3 is a schematic cross-sectional view illustrating a touch-sensitive control device according to an embodiment of the present invention;

FIG. 4 is a schematic cross-sectional view illustrating a touch-sensitive control device according to another embodiment of the present invention;

FIG. 5 is a schematic cross-sectional view illustrating a touch-sensitive control device according to a further embodiment of the present invention;

FIG. 6A is a schematic diagram exemplifying a layout of a flexible circuit board used in the touch-sensitive control device shown in FIG. 5;

FIG. 6B is a schematic diagram illustrating the flexible circuit board shown in FIG. 6A with a folded configuration;

FIG. 7 is a schematic cross-sectional view illustrating a touch-sensitive control device according to a still another embodiment of the present invention; and

FIG. 8 is a schematic cross-sectional view illustrating a touch-sensitive control device according to a still further embodiment of the present invention.

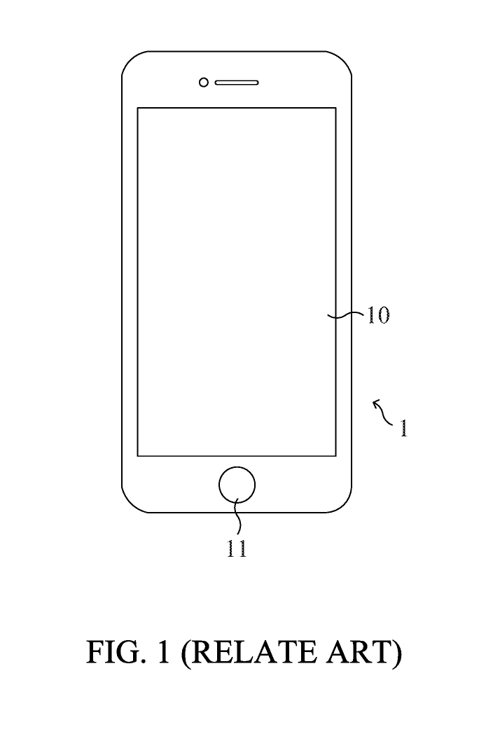

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

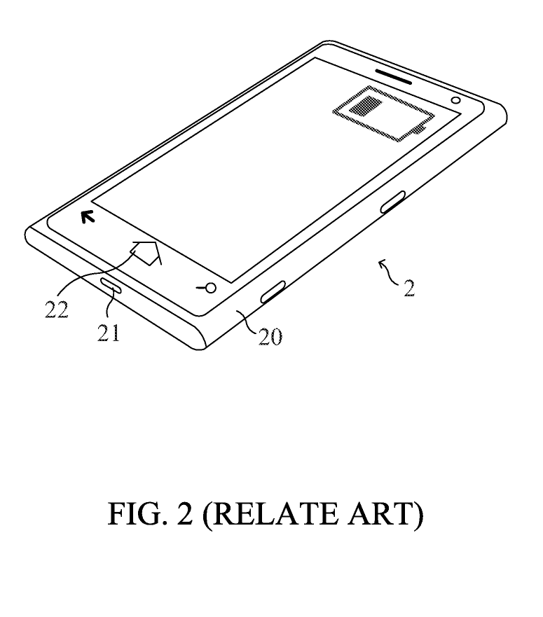

Please refer to FIG. 2, in which a smart phone having a touch-sensitive home key according to the present invention is schematically illustrated. The touch-sensitive home key 22 of the smart phone 2 is arranged on a surface of a housing 20, e.g. the top surface where the touch screen is disposed. The housing 20 is provided with an uncovered socket 21, which is, for example, a universal serial bus (USB) socket, for electric connection to a power source or an external device for electricity and/or data transmission. It is preferred that the touch-sensitive home key 22 is disposed near the socket 21 so that the touch-sensitive control can be conducted by making use of existing elements of the socket 21.

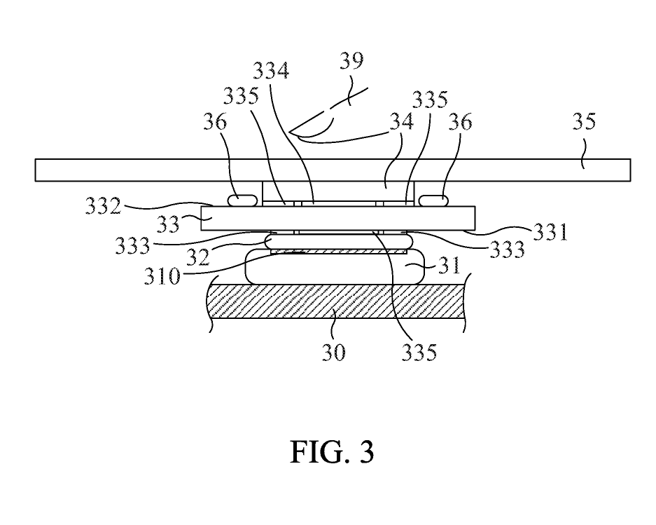

FIG. 3 schematically illustrates a touch-sensitive control device according to an embodiment of the present invention to configure the home key 22. The touch-sensitive control device includes a cover structure, a circuit board, a socket, and a spacer. The socket 31 may be configured like the socket 21 shown in FIG. 2. The socket 31 is mounted onto a main board 30 and includes a conductive member 310. The spacer 32 are provided on or over the socket 31 and disposed next to the circuit board 33. The spacer is made of an elastic and deformable material. The circuit board 33 includes a first electrode structure 333 formed on a first surface 331 thereof, and a second electrode structure 334 formed on a second surface 332 thereof. The circuit board 33 further includes a third electrode structure 335 on the first surface 331 and/or the second surface 332 thereof, covering the first electrode structure 333 but uncovering the second electrode structure 334 when viewed in a direction from the second surface 332 to the first direction 331. The first electrode structure 333 functions as a press-sensing electrode structure, the second electrode structure 334 functions as a touch-sensing electrode structure, and the third electrode structure 335 functions as a grounding electrode structure. For example, the spacer is disposed between and in contact with the conductive member 310 and the first electrode structure 333, as shown FIG. 3. Furthermore, the cover includes a cover lens 35 over the circuit board 33, and optionally a light guide plate 34, if light emitting diodes 36 are provided, for guiding and planarizing light from the light guide plate 34.

When a user's finger 39 touches the cover lens 35 and presses down, the spacer 32 deforms due to the pression so that a distance between the first electrode structure 333 and the conductive member 310 is reduced. In response to the distance change, a control chip electrically connected to the first electrode structure 333 and the conductive member 310 of the socket 31 (not shown) would measure capacitance variation between the first electrode structure 333 and the conductive member 310, wherein the conductive member 310 is set to be a ground electrode structure or a stimulus electrode structure by the control chip. Accordingly, a first control signal is generated in response to the pression. Meanwhile, due to the shielding effect of the overlying third electrode structure 335, substantially no capacitive coupling would occur between the finger 39 and the first electrode structure 333. In other words, the sliding of the finger 39 on or over the cover lens 35 would not interfere the capacitance variation resulting from the finger pression, and the first control signal reliably reflects the finger pression operation. In contrast, if a user just touches but not depresses the cover lens 35, the spacer 32 would not deform, and the distance between the first electrode structure 333 and the conductive member 310 would not change. Then the control chip would not sense any capacitance variation.

In addition to the pression operation, a sliding operation or a gesture with a user's finger may also be conducted on or above the cover lens 35. Since the second electrode structure 334 is not shielded by the third electrode structure 335, the sliding operation or gesture of the finger 39 can be sensed due to the capacitive coupling of the finger 39 to the second electrode structure 334. The control chip then generates a second control signal representing the sliding operation or gesture in response to capacitance change between a specified portion of the second electrode structure 334 and the finger 39. In this embodiment, a portion of the third electrode structure 335 is formed on the first surface 331, covering the second electrode structure 334 when viewed in a direction from the first surface 331 to the second surface 332, thereby shielding the second electrode structure 334 from an unconscious operation at the opposite side. All the portions of the third electrode structure 335 distributed on the first surface 331 and the second surface 332 are electrically connected to the control chip. The control chip provides a zero voltage, i.e. a ground voltage, or a constant voltage, e.g. several volts, to the third electrode structure 335 to have the third electrode structure 335 function as a ground electrode or a stimulus electrode. The stimulus electrode driven with the constant voltage can enhance sensitivity of the corresponding electrode structure. Taiwanese Patent Publication No. 201602862, which is entitled “Control Device” and assigned to the same assignee as the present application, and its counterpart Chinese Patent Application No. CN104777929A, can be referred to realize associated techniques.

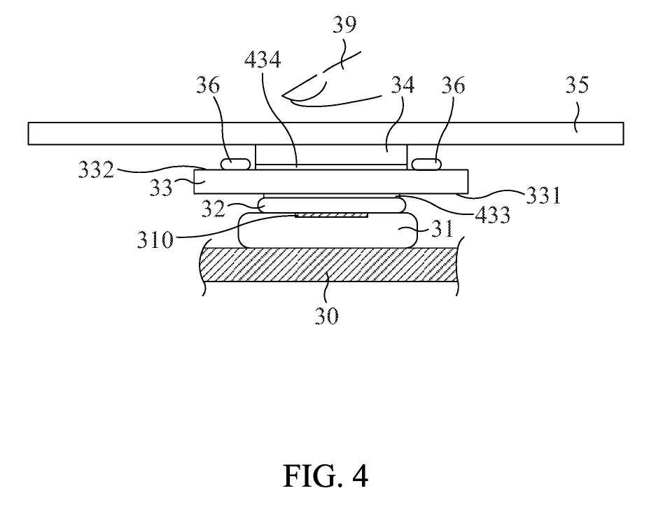

FIG. 4 schematically illustrates another embodiment of touch-sensitive control device according to the present invention to configure the home key 22. The touch-sensitive control device includes a cover structure, a circuit board, a socket, and a spacer. The socket 31 may be configured like the socket 21 shown in FIG. 2. The socket 31 is mounted onto a main board 30 and includes a buried conductive member 310. The spacer 32 provided on or over the socket 31 and disposed next to the circuit board 33. The spacer is made of an elastic and deformable material. The circuit board 33 includes a first electrode structure 433 formed on a first surface 331 thereof, and a second electrode structure 434 formed on a second surface 332 thereof. The second electrode structure 434 covers the first electrode structure when viewed in a direction from the second surface 332 to the first surface 331. The first electrode structure 433 and the second electrode structure 434 alternately serve as a press-sensing electrode, a touch-sensing electrode, and a grounding electrode in a time-division manner. Similar to the above-described embodiment, light-emitting diodes 36 and a light guide plate 34 are provided for uniform illumination, and a cover lens 35 is provided for protection.

In a first period of time, a press-sensing mode is executed. When a user's finger 39 touches the cover lens 35 and presses down, the spacer 32 deforms due to the pression so that a distance between the first electrode structure 433 and the conductive member 310 is reduced. In response to the distance change, a control chip electrically connected to the first electrode structure 433 and the conductive member 310 of the socket 31 (not shown) would measure capacitance variation between the first electrode structure 433 and the conductive member 310, wherein the conductive member 310 is set to be a ground electrode structure or a stimulus electrode structure by the control chip. Accordingly, a first control signal is generated in response to the pression. In the first period of time, the second electrode structure 434 is electrically connected to the control chip. The control chip provides a zero voltage to the second electrode structure 434 to have the second electrode structure 434 function as a ground electrode. Due to the shielding effect of the overlying second electrode structure 434, substantially no capacitive coupling would occur between the finger 39 and the first electrode structure 433. In other words, the sliding of the finger 39 on or over the cover lens 35 would not interfere the capacitance variation resulting from the finger pression, and the first control signal reliably reflects the finger pression operation. In contrast, if a user just touches but not depresses the cover lens 35, the spacer 32 would not deform, and the distance between the first electrode structure 433 and the conductive member 310 would not change. Then the control chip would not sense any capacitance variation.

In a second period of time, the control chip drives the second electrode structure 434 to execute a touch-sensing mode. In the touch-sensing mode, a sliding operation or a gesture of a user's finger on or above the cover lens 35 is detected. The sliding operation or gesture of the finger 39 can be sensed due to the capacitive coupling of the finger 39 to the second electrode structure 434. The control chip then generates a second control signal representing the sliding operation or gesture in response to capacitance change between a specified portion of the second electrode structure 434 and the finger 39. In the second period of time, the first electrode structure 433 is set to be a grounding electrode by the control chip. The control chip provides a zero voltage, i.e. a ground voltage, or a constant voltage, e.g. several volts, to the first electrode structure 433. The stimulus electrode driven with the constant voltage can enhance sensitivity of the corresponding electrode structure. Taiwanese Patent Publication No. 201602862, which is entitled “Control Device” and assigned to the same assignee as the present application can be referred to realize associated techniques. In this embodiment, the first period of time and the second period of time are entered by turns. In other words, press-sensing and touch-sensing functions are both executed in a time-division way. The structure of the touch-sensitive control device in this embodiment is simpler compared to the structure of the touch-sensitive control device as shown in FIG. 3. Nevertheless, the time-division touch-sensing control method is also applicable to the embodiment of the touch-sensing control device illustrated in FIG. 3.

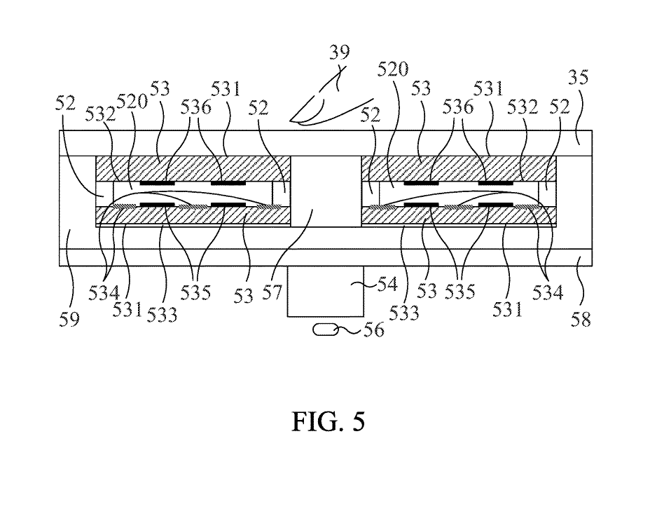

FIG. 5 schematically illustrates a further embodiment of touch-sensitive control device according to the present invention to configure the home key 22. In this embodiment, the touch-sensitive control device includes a flexible printed circuit (FPC) 53. Electrode structures are formed on a first surface e531 and a second surface 532 of the FPC 53. By way of a pattern-defining and microlithographic etching process, a first electrode structure 533, a second electrode structure 534, a third electrode structure 535 and a fourth electrode structure 536 are formed, and these electrode structures function as press-sensing, touch-sensing and grounding electrodes in various embodiments. The FPC 53 is folded to have an upper portion and a lower portion, and a spacer 52 is provided in a space between the upper portion and the lower portion of the FPC 53. The spacer 52 may be made of an elastic material. Alternatively, the spacer 52 may be just a space, leaving a gap 520 between the upper portion and the lower portion of the FPC 53. For example, the first electrode structure 533 is a grounding electrode, which is electrically coupled to a constant voltage, e.g. a zero voltage or a constant level voltage. The second electrode structure 534 serves as a touch-sensing electrode. By coupling the second electrode structure 534 to the first electrode structure 533, the second electrode structure 534 can be used for sensing a sliding operation or gesture of a user's finger 39 on or over the cover lens 35. The above-mentioned constant voltage is provided by an external control chip (not shown).

The third electrode structure 535 and the fourth electrode structure 536 function as a press-sensing electrode and a grounding electrode, respectively. When a user's finger 39 touches the cover lens 35 and presses down over the third electrode structure 535 and the fourth electrode structure 536, the cover lens 35 is depressed by the finger 39 so as to push the third electrode structure 535 toward the fourth electrode structure 536. With the reduction of the distance between the third and fourth electrode structures 535 and 536, the capacitance therebetween changes as well. The control chip electrically coupled to the third and fourth electrode structures 535 and 536 then senses the capacitance variation, wherein the fourth electrode 536 structure is set to be a grounding electrode by the control chip, thereby generating a first control signal indicative of a pressing operation. In contrast, if a user just touches but not depresses the cover lens 35, the spacer 32 would not deform, and the distance between the third electrode structure 535 and the fourth electrode structure 536 would not change. Then the control chip would not sense any capacitance variation.

In addition to the pression operation, a sliding operation or a gesture with a user's finger may also be conducted on or above the cover lens 35. Since the second electrode structure 534 is not shielded by any conductive material, the sliding operation or gesture of the finger 39 can be sensed due to the capacitive coupling of the finger 39 to the second electrode structure 534. The control chip then generates a second control signal representing the sliding operation or gesture in response to capacitance change between a specified portion of the second electrode structure 534 and the finger 39. In this embodiment, the first electrode structure 533 is formed on the first surface 331, covering the second electrode structure 534 when viewed in a direction from the first surface 531 to the second surface 532, thereby shielding the second electrode structure 534 from an unconscious operation at the opposite side. The first electrode structure 533 and the fourth electrode structure 536 are both electrically connected to a control chip (not shown) for receiving a zero voltage, i.e. a ground voltage, or a constant voltage, e.g. several volts. The stimulus electrode driven with the constant voltage can enhance sensitivity of the corresponding electrode structure. Taiwanese Patent Publication No. 201602862, which is entitled “Control Device” and assigned to the same assignee as the present application can be referred to realize associated techniques. As for the light guide plate 54 used for guiding light from the light-emitting diodes 56 to penetrate through holes 57 so that the user can clearly see the home key and other keys. The light guide plate 54 and the light-emitting diodes 56 are formed on a circuit board 58. The FPC 53 may be disposed inside a frame 59. The frame 59 is disposed under a lower edge of the cover lens 35 for supporting the cover lens 35. The control chip may be directly mounted onto the FPC 53, or mounted onto the circuit board 58.

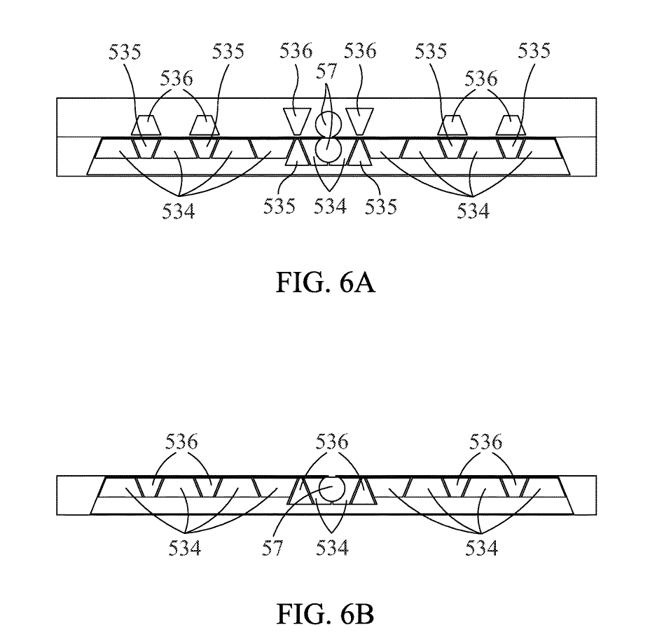

FIG. 6A schematically illustrates an exemplified layout of the second electrode structure 534, the third electrode structure 535 and the fourth electrode structure 536 of the FPC 53 as shown in FIG. 5. When folding the FPC of FIG. 6A along the line 60, a configuration as shown in FIG. 6B can be seen.

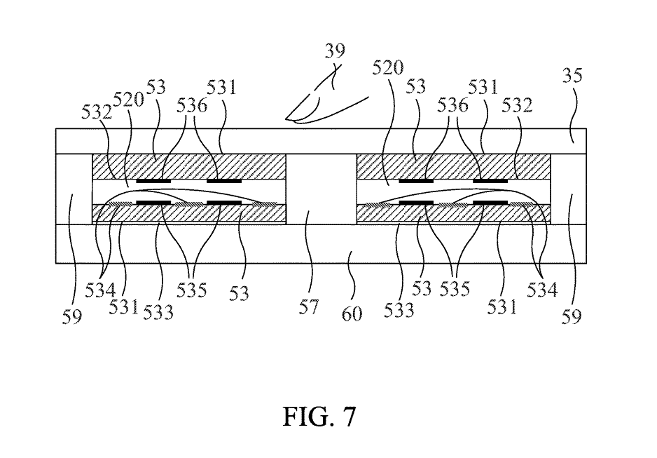

FIG. 7 schematically illustrates still another embodiment of touch-sensitive control device according to the present invention to configure the home key 22. The touch-sensitive control device in this embodiment is similar to that as shown in FIG. 5 except that a first surface 531 of the FPC 53 is attached onto a substrate 60. The substrate 60 may be a rigid substrate, e.g. a glass fiber epoxy substrate FR4. By securing the substrate 60 to the frame 59, the FPC 53 can be among the substrate 60, the frame 59 and the cover lens 35. In this way, the folded FPC 53 inherently sustains against the cover lens 35 with a gap 520 even though a spacer 520 is absent. Such a structure can be maintained by unlocking the frame 59, thereby allowing the FPC 53 to be adjusted or replaced.

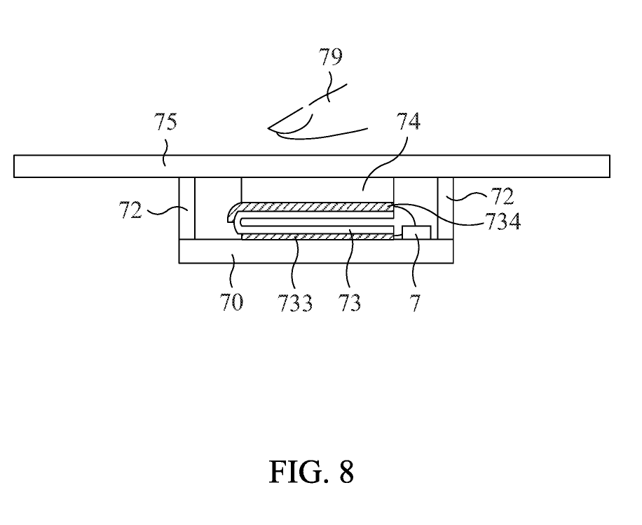

Furthermore, in the embodiment as shown in FIG. 8, a main board 70 includes a FPC 73, which is formed with a first electrode structure 733 and a second electrode structure 734. The first and second electrode structures alternately function as a press-sensing electrode, a touch-sensing electrode and a grounding electrode in a time-division manner. The second electrode structure 734 is attached onto a surface of a light guide plate 74, following the curvature of the FPC 73. If the light guide plate 74 is omitted, the bent portion of the FPC 73 would be attached onto a surface of the cover lens 75. The light guide plate 74 is used for guiding light from the light-emitting diode to provide a planarized light source.

When the user's finger 79 touches the cover lens 75 and presses down, the spacer 72 made of an elastic material would deform accordingly. If the spacer 72 is made of a rigid material, it is required that the cover lens 775 is deformable. With deformation of either the spacer 72 or the cover lens 75, a distance between the first electrode structure 733 and the second electrode structure 734 would change. In response to the distance change, a control chip 7 electrically connected to the first electrode structure 733 and the second electrode structure 734 would measure capacitance variation between the first electrode structure 733 and the second electrode structure 734. Accordingly, a first control signal is generated in response to the pression. In another period of time, a sliding operation or a gesture with a user's finger can be conducted on or above the cover lens 35 as the second electrode structure 734 is not shielded from the finger 79 by any conductive member. The sliding operation or gesture of the finger 39 can be sensed due to the capacitive coupling of the finger 79 to the second electrode structure 734. The control chip then generates a second control signal representing the sliding operation or gesture in response to capacitance change between a specified portion of the second electrode structure 734 and the finger 79.

It is understood from the above descriptions that the present invention provides a touch-sensitive control device that may be used in a push button of a smart phone. The touch-sensitive control device according to the present invention can feed back feeling of press while being pushed by taking advantages of existing elements of the smart phone, e.g. a USB socket, or with a simple design.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch-sensitive control device, controlled by a control chip to conduct press sensing and/or touch sensing, comprising:
a cover;
a circuit board disposed at a side of the cover, having a first surface disposed opposite to the cover, and having a second surface facing the cover;
a first electrode disposed on the first surface of the circuit board and electrically connected to a control chip;
a socket having a conductor; and
a spacer disposed between the socket and the first surface of the circuit board, and deformable to change a distance between the first electrode and the conductor,
wherein a capacitance change between the first electrode and the conductor of the socket correlates to the distance change between the first electrode and the conductor resulting from a pressing operation onto the cover.

2. The touch-sensitive control device according to claim 1, further comprising:
a second electrode disposed on the second surface of the circuit board and electrically connected to the control chip; and
a third electrode disposed on the first surface of the circuit board and electrically connected to the control chip,
wherein the second electrode is capacitively coupled to the third electrode, and a capacitance change between the second electrode and the third electrode correlates to a touching operation on or over the cover.

3. The touch-sensitive control device according to claim 2, wherein the third electrode structure is further provided on the second surface of the circuit board and electrically connected to the control chip, and overlies the first electrode structure on the first surface of the circuit board so as to shield the first electrode structure from capacitive interference.

4. The touch-sensitive control device according to claim 1, further comprising a second electrode disposed on the second surface of the circuit board and electrically connected to the control chip, wherein a capacitance change of the second electrode is measured by the control chip in response to a touching operation on or over the cover.

5. A touch-sensitive control device, comprising:
a cover;
a control chip;
a circuit board disposed at a side of the cover, having a first surface disposed opposite to the cover, and having a second surface facing the cover;
a first electrode disposed on the first surface of the circuit board and electrically connected to a control chip;
a socket having a conductor; and
a spacer disposed between the socket and the first surface of the circuit board, and deformable to change a distance between the first electrode and the conductor,
wherein the control chip generates a first control signal in response to a capacitance change between the first electrode and the conductor of the socket in a first period of time, and the capacitance change correlates to a distance change between the first electrode and the conductor in response to a pressing operation on the cover.

6. The touch-sensitive control device according to claim 5, further comprising:
a second electrode disposed on the second surface of the circuit board and electrically connected to the control chip; and
a third electrode disposed on the first surface of the circuit board and electrically connected to the control chip,
wherein the control chip generates a second control signal in response to a capacitance change between the second electrode and the third electrode in a second period of time, and the capacitance change correlates to a distance change between the second electrode and the third electrode in response to a touch-sensing operation on or over the cover.

7. The touch-sensitive control device according to claim 6, wherein the third electrode is further provided on the second surface of the circuit board and electrically connected to the control chip, and overlies the first electrode on the first surface of the circuit board so as to shield the first electrode from capacitive interference in the press-sensing operation.

8. The touch-sensitive control device according to claim 5, further comprising a second electrode disposed on the second surface of the circuit board and electrically connected to the control chip, wherein the control chip generates a second control signal in response to a capacitance change of the second electrode in a second period of time, and the capacitance change occurs in response to a touching operation on or over the cover.

9. The touch-sensitive control device according to claim 8, wherein the control chip provides a constant level of voltage to the first electrode in the second period of time to make the first electrode function as a grounding electrode.

10. A touch-sensitive control device, controlled by a control chip to conduct press sensing and/or touch sensing, comprising:
a cover;
a flexible circuit board disposed at a side of the cover and folded to define an upper portion and a lower portion;
a first electrode disposed at an inner surface of the lower portion facing the upper portion, and electrically connected to the control chip;
a second electrode disposed at an inner surface of the upper portion facing the lower portion, and electrically connected to the control chip; and
a spacer disposed between the first portion and the second portion of the flexible circuit board for creating a variable gap between the first electrode and the second electrode,
wherein a distance between the first electrode and the second electrode changes in response to a pressing operation, and a capacitance change between the first electrode and the second electrode correlates to the distance change.

11. The touch-sensitive control device according to claim 10, further comprising:
a third electrode disposed at an inner surface of the lower portion facing the upper portion, and electrically connected to the control chip; and
a fourth electrode disposed at the outer surface of the lower portion opposite the upper portion, and electrically connected to the control chip,
wherein the third electrode is capacitively coupled to the fourth electrode, and a capacitance change between the third electrode and the fourth electrode is measured by the control chip in response to a touching operation on or over the cover.

12. A touch-sensitive control device, comprising:
a cover;
a control chip;
a flexible circuit board disposed at a side of the cover and folded to define an upper portion and a lower portion;
a first electrode disposed at an outer surface of the lower portion opposite to the upper portion, and electrically connected to the control chip;
a second electrode disposed at an outer surface of the upper portion opposite to the lower portion, and electrically connected to the control chip; and
a spacer disposed between the first portion and the second portion of the flexible circuit board for creating a variable gap between the first portion and the second portion,
wherein the control chip generates a first control signal in response to a capacitance change between the first electrode and the second electrode in a first period of time, and the capacitance change correlates to a distance change between the first electrode and the second electrode in response to a pressing operation on the cover.

13. The touch-sensitive control device according to claim 12, wherein the control chip generates a second control signal in response to a capacitance change of the second electrode in a second period of time, and the capacitance change occurs in response to a touching operation on or over the cover.
